(19) United States
(12) Patent Application Publication
(10) Pub. No.: US 2007/0274251 A1
(43) Pub. Date: Nov. 29, 2007

(54) COMMUNICATION DEVICE FOR TIME ZONE CALCULATION AND METHOD THEREOF

(76) Inventor: Tadanori Hagihara, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/420,770

(22) Filed: May 29, 2006

(51) Int. Cl. H04Q 7/00

(52) U.S. Cl. 370/328

(57) ABSTRACT

A method for displaying entries of a contact list on a first communication device is disclosed. The method includes: associating at least a specific time zone with an entry in the contact list; and when the entry is referenced, determining a specific local time associated with the entry according to a local time of the communication device, the specific time zone, and a time zone of the first communication device, and displaying the specific local time.

### BACKGROUND

The present invention relates to a method and device for displaying entries of a contact list, and more particularly, to a method and device for displaying entries of a contact list with local time displayed.

The ability to travel about the globe has become faster and easier. As a result, the utilization of communication devices, such as cellular phones, is more global and international than in the past. Friends, family, and business associates can easily be scattered around the world thereby residing in many different time zones.

Please note, in telephony, a caller, also known as the A-party, is the person or party who originates or dials a telephone call. The B-party is the person who is being called or receives or answers the call. Throughout the following background and subsequent following disclosure A-party is the person placing the call and B-party is the person receiving the call as per the standard convention.

Currently, the A-party of a communication device must determine, when placing a particular call, if it is appropriate to place the call based on the local time of the B-party (i.e., the local time associated with the person called). For the A-party to determine the appropriateness of a call, it is important to know the local time of the B-party. If the local time of the B-party is 2 a.m. then the A-party may consider waiting unless the call is deemed urgent. This calculation is difficult and inconvenient since B-party may be located in a time zone very different from A-party's time zone. In addition, the caller has to spend much time determining the local time of the B-party manually.

The current related art methods and devices for the A-party to accurately determine the B-party's local time are insufficient. Therefore, it is apparent that novel methods and devices that support local time identification are needed.

### SUMMARY

It is therefore one of the objectives of the claimed disclosure to provide a method for displaying entries of a contact list on a first communication device according to specific time zones and the related apparatus thereof, to solve the above mentioned problems.

According to an embodiment of the claimed disclosure, a method for displaying entries of a contact list, the contact list having a plurality of entries for storing names, and telephone numbers, on a first communication device is disclosed. The method includes: associating at least a specific time zone with an entry in the contact list; and when the entry is referenced, determining a specific local time associated with the entry according to a local time of the communication device, the specific time zone, and a time zone of the communication device, and displaying the specific local time.

According to an embodiment of the claimed disclosure, a communication device for displaying entries of a contact list, the contact list having a plurality of entries for storing names, and telephone numbers is disclosed. The communication device includes: a storage device and a microprocessor. The storage device is for storing a program execution code, the contact list, and settings. The microprocessor executes the program execution code to associate at least a specific time zone with an entry in the contact list, determines a specific local time associated with the entry according to a local time of the first communication device, the specific time zone, and a time zone of the communication device, and displays the specific local time, wherein the specific time zone is selected from a plurality of time zones stored in the settings, the local time of the communication device is stored in the settings, and the time zone of the communication device is stored in the settings.

The present disclosure methods and communication device for displaying local time of the entries of a contact list/call log immediately calculates the local time of A-party and B-party and A-party's actual location according to the country code should it vary from the time zone information set in the contact list. Access to this immediate local time offers tremendous utility to the user of the communication device in determining how appropriate a particular phone call may be prior to placing the phone call.

These and other objectives of the present disclosure will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a communication device according to an embodiment of the present disclosure.

FIG. 2 illustrates a user interface diagram of a first selection of a contact list/address book of the communication device of FIG. 1 according to an embodiment of the present disclosure.

FIG. 3 illustrates a user interface diagram of a second selection of the contact list/address book of the communication device of FIG. 1 according to an embodiment of the present disclosure.

FIG. 4 illustrates a user interface diagram of setting an entry in the contact list of FIG. 1 according to an embodiment of the present invention.

FIG. 5 illustrates a user interface diagram of setting an entry in the contact list of FIG. 1 according to another embodiment of the present invention.

FIG. 6 illustrates a user interface diagram of a call log/history of the communication device of FIG. 1 according to an embodiment of the present disclosure.

FIG. 7 illustrates a user interface diagram of a call log/history of the communication device of FIG. 1 according to another embodiment of the present disclosure.

FIG. 8 is a flowchart showing a method for displaying entries of a contact list according to an embodiment of the present disclosure.

FIG. 9 illustrates a user interface diagram of the communication device of FIG. 1 receiving an incoming call with time zone information available according to an embodiment of the present disclosure.

FIG. 10 illustrates a user interface diagram of the communication device of FIG. 1 receiving an incoming call with time zone information available when A-party is traveling abroad according to an embodiment of the present disclosure.

FIG. 11 illustrates a user interface diagram of the communication device of FIG. 1 when terminating the incoming call of FIG. 10 according to an embodiment of the present disclosure.

FIG. 12 is a flowchart showing a method for displaying entries of a contact list when the communication device of FIG. 1 receiving an incoming call according to an embodiment of the present disclosure.

FIG. 13 illustrates a user interface diagram of the call log/history of the communication device of FIG. 1 when an outgoing call was placed or an incoming call was received according to an embodiment of the present disclosure.

FIG. 14 illustrates a user interface diagram of the communication device of FIG. 1 when an incoming call was received and A-party is traveling abroad according to an embodiment of the present disclosure.

FIG. 15 illustrates a user interface diagram of the communication device of FIG. 1 when an incoming call was received and A-party is traveling abroad in a country that has more than one time zone according to an embodiment of the present disclosure.

FIG. 16 is a flowchart showing a method for displaying entries of a call log/history of the communication device of FIG. 1 according to an embodiment of the present disclosure.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

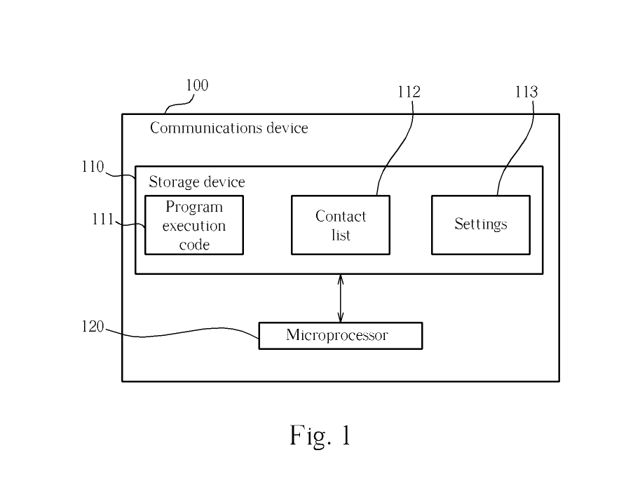

Please refer to FIG. 1. FIG. 1 is a block diagram of a communication device 100 according to an embodiment of the present disclosure. In this embodiment of the present disclosure the communication device 100 is a mobile/cellular phone. However, this is not meant to be taken as a limitation of the present invention. As shown in FIG. 1, the communication device 100 includes a storage device 110 and a microprocessor 120. The storage device 110 is used to store entries of a contact list 112 (i.e., an electronic phone book), including but not limited to: names, and telephone numbers. Additionally, the storage device 110 stores a program execution code 111 and settings 113. The microprocessor 120 is coupled to the storage device 110 and is capable of executing the program execution code 111 to perform the desired local time identification. Please note that details regarding the settings 113 are provided throughout the present disclosure.

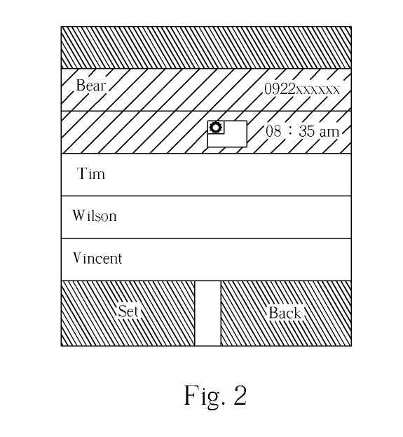

The details of the operation of the program execution code 111 are as follows. The program execution code 111 associates at least a specific time zone with an entry in the contact list 112. Please refer to FIG. 2. FIG. 2 illustrates a user interface diagram of a first selection of the contact list 112 shown in FIG. 1. By way of example, and not limitation, user interface diagrams are provided in the figures; however, many variations are possible while maintaining and obeying the spirit of the present disclosure. As shown in FIG. 2, the entry named Bear is currently selected in the contact list 112. A Taiwan flag is displayed with the entry Bear indicating that Bear is located in Taiwan. The entry also displays 8:35 a.m. This is Bear's local time according to the time zone associated with Bear's entry in the contact list 112 and using the local time of the communication device 100 as a reference. The local time of the communication device 100 is stored in the settings 113. It is well known to those of average skill in the art how to input the local time, for example, in a mobile phone according to this embodiment, therefore additional details are omitted for the sake of brevity.

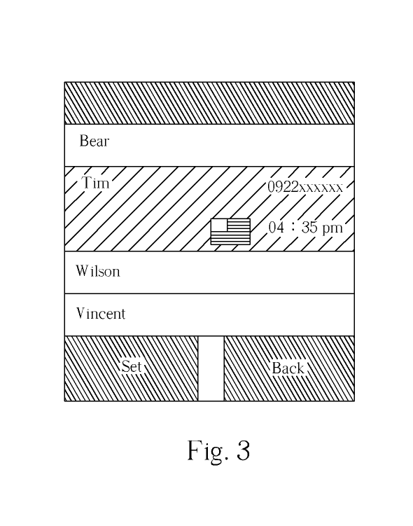

Please refer to FIG. 3. FIG. 3 illustrates a user interface diagram of a second selection of the contact list 112 shown in FIG. 1. As shown in FIG. 3, the entry named Tim is currently selected in the contact list 112. A USA flag is displayed with the entry Tim indicating that Tim is located in the USA. The entry also displays 4:35 p.m. This is Tim's local time according to the time zone associated with Tim's entry in the contact list 112, the time zone where the communication device 100 is located, and using the local time (system time) of the communication device 100 as a reference. Please note, utilizing the local time of the communication device 100 as a starting point, and thereafter calculating a local time of any other location on our planet utilizing time zones is a well-known calculation that can be realized in many ways. Tables (not shown) of information, if needed based on the particular method of local time calculation, can be easily included in the settings 113 and the program execution code 111 can easily access said settings 113. For example, the well-known and standardized GMT time zone system can be used but is provided here as an example and is not a limitation of the present disclosure. Details of GMT and related calculation for local time based on GMT time zones are omitted, as they are well known to those skilled in this art.

Regarding FIG. 2 and FIG. 3, the program execution code 111 is used to determine the local time associated with the selected entry of the contact list 112. The program execution code 111 utilizes the local time of the communication device 100, the time zone associated with the selected entry of the contact list 112, and the time zone that is assigned to the communication device 100. The program execution code 111 then displays the calculated local time of the selected entry of the contact list 112. By way of example, and not limitation, the available time zones, the local time of the communication device 100, and the time zone of the communication device 100 can be stored in the settings 113. The program execution code 111 calculates the local time of the selected entry and there after displays the local time as shown in FIG. 2 and FIG. 3 by performing well known calculations using said time zone of the entry and said local time and time zone of the communication device 100.

Furthermore, it could be easily understood that in addition to the time information and country information, the date information of the selected entry can also be shown on the user interfaces of FIGS. 2 and 3.

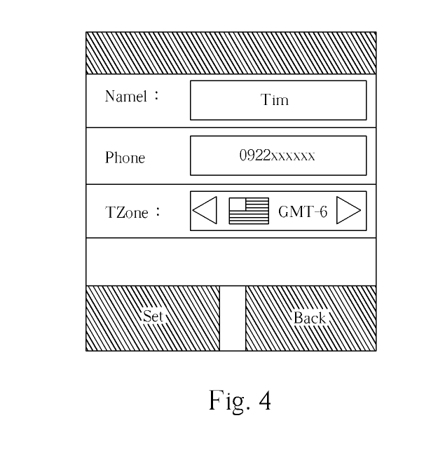

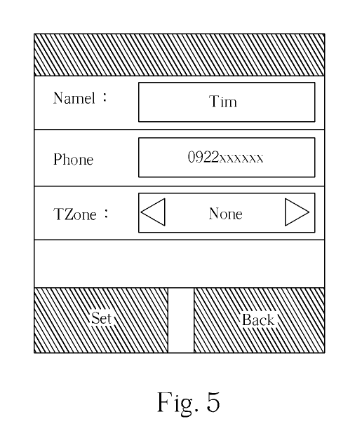

Please refer to FIG. 4 and FIG. 5. FIG. 4 illustrates a user interface diagram of setting an entry in the contact list 112 shown in FIG. 1 according to an embodiment of the present invention. FIG. 5 illustrates a user interface diagram of setting an entry in the contact list 112 shown in FIG. 1 according to another embodiment of the present invention. As shown in FIG. 4, three fields, Name, Phone, and TZone, are displayed for receiving user input. Tim's local time shown in FIG. 3, as described earlier, is calculated partially relying on the TZone field set by the user of the communication device 100. As shown in FIG. 4, the TZone field is set together with the country information. As shown in FIG. 5, the TZone field is allowed to be set to none. In this case, Tim's local time would not be displayed because it cannot be calculated by the program execution code 111.

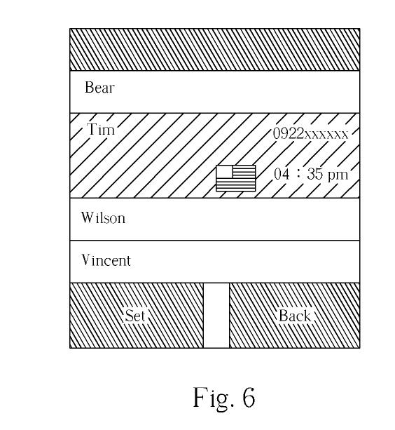

Please refer to FIG. 6. FIG. 6 illustrates a user interface diagram of a call log/history of the communication device 100 of FIG. 1 according to one embodiment of the present invention. As shown in FIG. 6, a user of the communication device 100 sees the country, as indicated by the flag icon, and the local time of the selected entry of the call log/history. In FIG. 6, the program execution code 111 executed by the microprocessor 120 calculates and displays Tim's local time and Tim's country (i.e., the flag icon) based on Tim's TZone field setting in the contact list 112 according to FIG. 4.

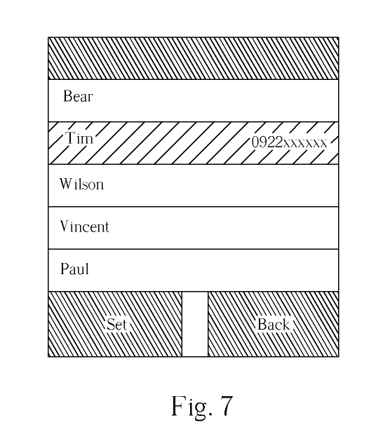

Please refer to FIG. 7. FIG. 7 illustrates a user interface diagram of a call log/history of the communication device 100 of FIG. 1 according to another embodiment of the present invention. As shown in FIG. 7, the user of the communication device 100 does not see the country, as indicated by the lack of the flag icon, and does not see the local time of the selected entry of the call log/history. In FIG. 7, the program execution code 111 cannot calculate and display Tim's local time and Tim's country based on Tim's TZone setting because, according to FIG. 5, Tim's TZone field setting in the contact list 112 is none.

Similarly, in addition to the time information and country information, the date information of the selected entry can also be shown on the user interfaces of FIGS. 6 and 7.

It should be noted that the display of call log/history is based on the information in the contact list 112 in the phonebook. In other words, displaying a selected entry of the call log is equivalent to displaying an entry of the contact list 112 corresponding to the same name. In the following, navigating the contact list 112 is equivalent to viewing the call log/history.

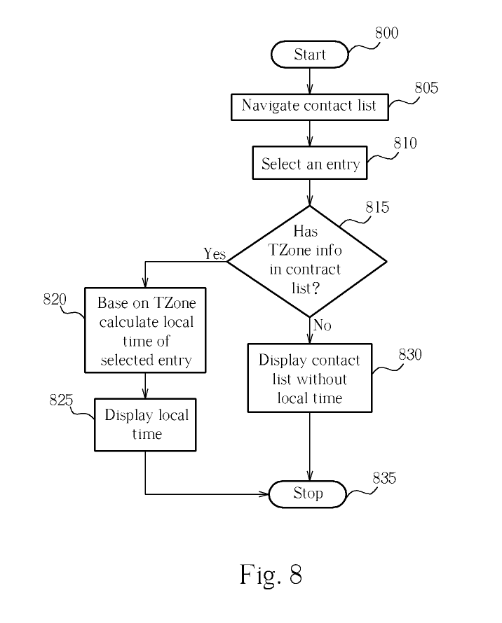

Please refer to FIG. 8. FIG. 8 is a flowchart showing a method for displaying entries of the contact list 112 according to an embodiment of the present invention. When a user of the communication device 100 wants to make a call, he can directly navigate entries of the contact list 112 as shown in FIG. 2 and FIG. 3, or navigate the entries in the call log/history as shown in FIG. 6 and FIG. 7. The call log here could be a record of received calls or placed calls or missed calls, and also could be a record comprising received calls, placed calls, and missed calls. The method of the present invention comprises the following steps:

Step 800: Start.

Step 805: Navigate contact list 112.

Step 810: Select an entry.

Step 815: Does the selected entry in contact list 112 have TZone information? If yes, go to step 820. If no, go to step 830.

Step 820: Calculate selected entry's local time based on TZone field of selected entry.

Step 825: Display selected entry and its associated local time. Go to step 835.

Step 830: Display selected entry without local time. Go to step 835.

Step 835: Stop.

The flow beings in step 800. In step 805, the user of the communication device 100 navigates the contact list 112. In step 810, the present disclosure defines the selected entry as the entry of the control list 112 that was most recently selected (i.e., the selected entry of the contact list 112 is the entry that is highlighted). In step 815, the TZone field associated with the selected entry is referenced. If the TZone field of the selected entry contains time zone information then the program execution code 111 of the present disclosure is able to calculate, and later display, the local time associated with the geographic location of the person of the selected entry of the contact list 112. If the time zone information is not available, then the flow jumps to step 830 where no local time calculations are performed and the entry of the contact list 112 is displayed as shown in FIG. 7 without local time and without the country flag-identifying icon. Otherwise, in step 825 the local time is calculated and displayed with the selected entry. In step 835 the flow stops.

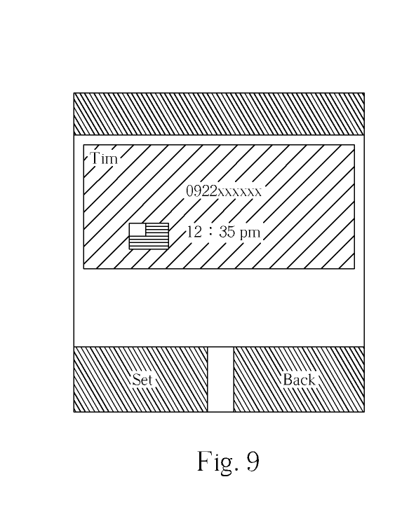

Please refer to FIG. 9. FIG. 9 illustrates a user interface diagram of the communication device of FIG. 1 receiving an incoming call with time zone information available according to an embodiment of the present disclosure. As shown in FIG. 9, A-party has placed a call to B-party. B-party is the party (i.e., user) that is using the communication device 100 and A-party is Tim. As shown in FIG. 9, Tim's local time and the country flag icon associated with Tim's TZone field set in the contact list 112 is displayed on the communication device 100 to alert B-party that an incoming call from A-party has arrived. The present disclosure communication device 100 calculates Tim's local time, shown as 12:30 p.m. according to Tim's TZone field set in the contact list 112. If an incoming call is associated with an entry in the contact list 112 not having TZone information available or if an incoming call is not associated with any entry of the contact list 112 then a standard incoming call announcement/screen display can be utilized. If Tim's phone number does not include a country code (i.e., a country identifier) then the present disclosure executes according to FIG. 9. If Tim's phone number includes the country code and if the country code matches the TZone field in Tim's contact list 112 entry, then the communication device 100 executes according to FIG. 9.

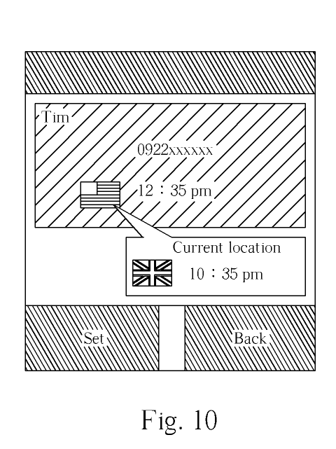

Please refer to FIG. 10. FIG. 10 illustrates a user interface diagram of the communication device of FIG. 1 receiving an incoming call with time zone information available when A-party is traveling abroad according to an embodiment of the present disclosure. As shown in FIG. 10, Tim has placed another incoming call, however, Tim's phone number includes a country code. The program execution code 111 detects the country code transmitted via the incoming call and compares the identified country code to the TZone field associated with A-party's contact list 112 entry. If the time zones do not match then apparently A-party is calling from a location different from that defined by the TZone information in A-party's contact list 112 entry. In this case, as shown in FIG. 10, the local time is calculated and displayed according to the TZone field in the A-party's entry in the contact list 112, and an additional window is displayed indicating that the original location (i.e., the location based on the TZone information in the A-party's entry of the contact list 112) is different from the current location based on the time zone associated with the country code included in the phone number of the incoming call. Also displayed in the additional window is the local time of the current location and another flag icon associated with the current location. The operation of retrieving the country code from the phone number of the incoming call is well known to a person of average skill in the pertinent art, therefore, additional details are omitted for the sake of brevity.

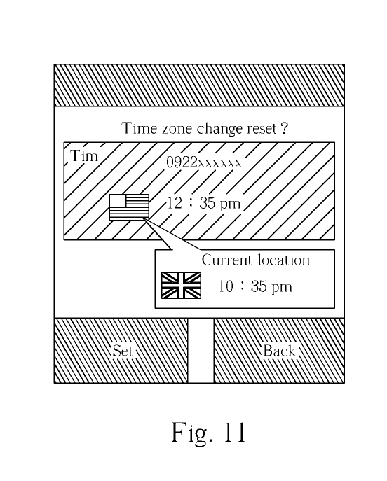

Please refer to FIG. 11. FIG. 11 illustrates a user interface diagram of the communication device of FIG. 1 when terminating the incoming call of FIG. 10 according to an embodiment of the present disclosure. In FIG. 11, B-party is prompted to reset/update the stored TZone information for A-party's entry in the contact list 112 or to leave the stored contact list 112 untouched. Any updated TZone information is stored in the TZone field of one entry in the contact list 112 that is stored in the storage device 110. Specifically in FIG. 11, Tim's local time according to Tim's TZone field in the contact list 112 is shown as 12:35 p.m., however, due to Tim's travels it is shown that Tim is calling B-party from England as indicated by the English flag and the local time there is shown as 10:35 p.m. Obviously, as with all of the user interfaces of the present disclosure, many variations are possible and the figures described herein are by way of example and not limitation. Variations, even significant, to the user interface elements, as is well known to those of average skill in this art, do not alter the spirit of the present disclosure.

Similarly, in addition to the time information and country information, the date information of the selected entry can also be shown on the user interfaces of FIGS. 9, 10 and 11.

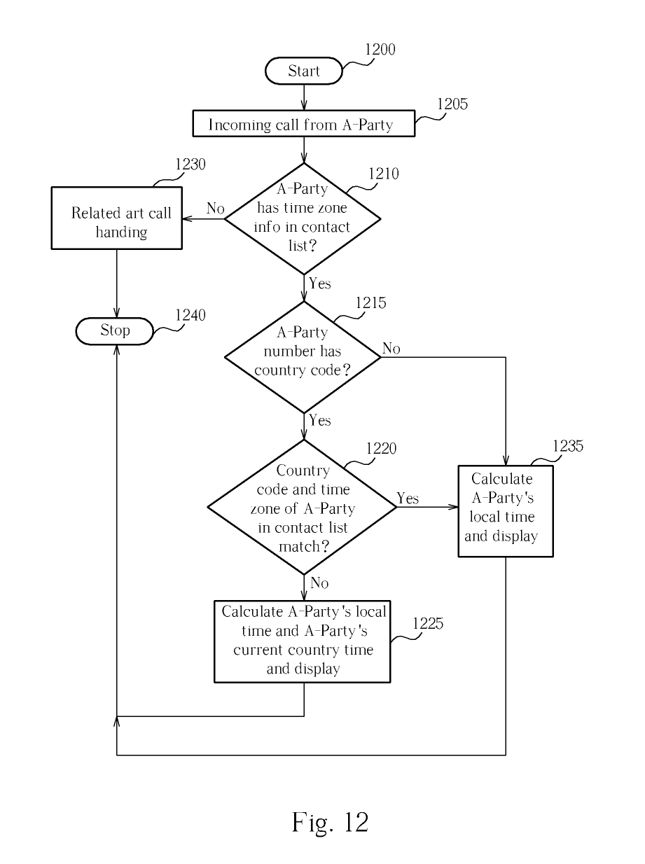

Please refer to FIG. 12. FIG. 12 is a flowchart showing a method for displaying entries of a contact list when the communication device of FIG. 1 receiving an incoming call according to an embodiment of the present disclosure. The method of the present invention comprises the following steps:

Step 1200: Start.

Step 1205: An incoming call from A-party is received by B-party.

Step 1210: Check if A-Party has TZone information in the contact list 112? If yes, go to step 1215. If no, go to step 1230.

Step 1215: Check if A-Party's incoming call has a country code. If yes, then go to step 1220. If no, then go to step 1235.

Step 1220: Check if A-party's incoming call's country code and A-party's contact list 112 TZone field match. If no, then go to step 1225. If yes, then go to step 1235.

Step 1225: Calculate A-party's local time according to TZone field of A-party's contact list 112 and calculate A-party's current country time according to country code and display. Go to step 1240.

Step 1230: Display information according to the conventional incoming call handling. Go to step 1240.

Step 1235: Calculate A-party's local time according to TZone field of A-party's contact list 112 and display.

Step 1240: Stop.

The flow beings with step 1200. In step 1205, the user of the communication device 100, B-party, receives an incoming call from A-party, in this example, someone named Tim. In step 1210, A-party's TZone information in the contact 112 is checked. If TZone information exists then go to step 1215. If not, the remainder of the call handling, particularly the display to the communication device 100, is handled in the typical way that the related art handles this procedure. In other words, no TZone information in the contact list 112 is available, therefore no local time can be calculated or displayed and the flow terminates with step 1240. In step 1215, if A-party's incoming phone number contains a country code, then continue to step 1220. Otherwise, go to step 1235, calculating A-party's local time according to A-party's contact list 112 TZone information, displaying the calculated local time, and then terminating at step 1240. In step 1220, it has been determined that A-party's incoming phone number has a country code. Said country code is compared to A-party's TZone field in the contact list 112. If these match, then flow to step 1235 to display the local time of A-party and then continue to termination in step 1240. Otherwise, in step 1225, because A-party's country code does not match A-party's contact list 112 TZone field, calculate A-party's local time according to A-party's TZone field in contact list 112, calculate A-party's current local time according to A-party's country code of the incoming phone number, and display this information on the communication device 100. Finally, the flow terminates with step 1240.

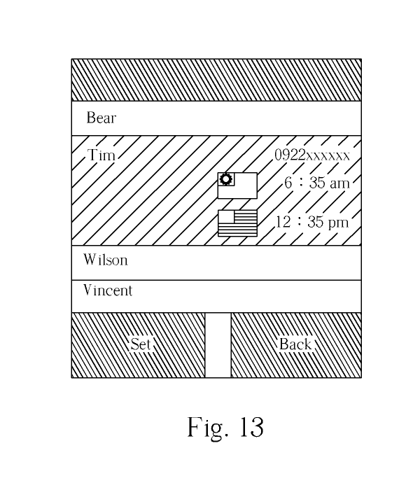

Please refer to FIG. 13. FIG. 13 illustrates a user interface diagram of the call log/history of the communication device of FIG. 1 according to an embodiment of the present disclosure. The call log of the communication device 100 is shown, specifically, calls received from/placed to Bear, Tim, Wilson, and Vincent are shown. The selected entry in the call log is the call received from Tim. As shown, the local time of the communication device 100 when the call from Tim was received was 6:35 a.m. and the call was received in Taiwan as indicated by the Taiwan flag icon. Additionally, Tim's local time was 12:35 p.m. as shown and Tim was located in the United States when he placed this call as shown by the US flag icon. The difference between the call log shown in FIG. 13 and the call log shown in FIG. 3 is that in addition to the information associated with the call from Tim, the information associated with the communication device 100 is shown in the selected entry of the call log in FIG. 13.

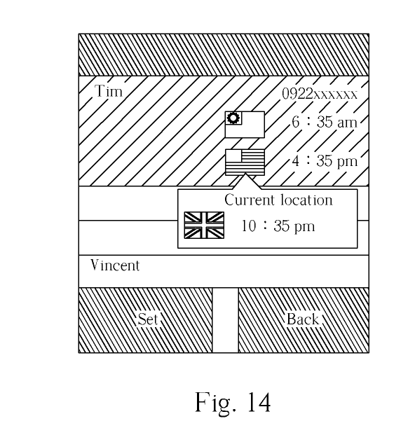

Please refer to FIG. 14. FIG. 14 illustrates a user interface diagram of the communication device of FIG. 1 when an incoming call was received and A-party was traveling abroad according to an embodiment of the present disclosure. Similar to FIG. 13 in all ways, but in FIG. 14 it is shown that Tim was traveling to England when the call was placed. Again, the local time of the communication device 100 is shown as 6:35 a.m. as being in Taiwan and Tim's local time according to Tim's TZone field in the contact list 112 is shown as 4:35 p.m., however, Tim's actual local time of 10:35 p.m. in his actual location, due to travel, is shown in the word bubble labeled current location.

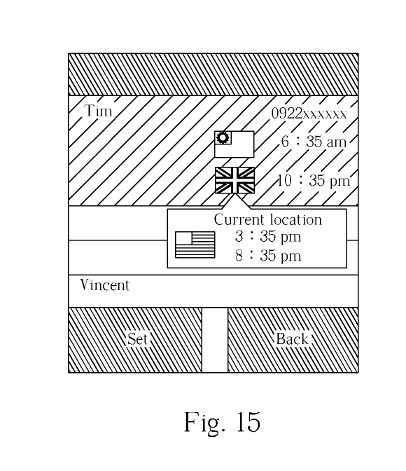

Please refer to FIG. 15. FIG. 15 illustrates a user interface diagram of the communication device of FIG. 1 when an incoming call was received and A-party was traveling abroad in a country that has more than one time zone according to an embodiment of the present disclosure. In FIG. 15 it is necessary to calculate a time range because in FIG. 15 Tim is traveling in the USA where there are several time zones. Because the incoming call's country code can not indicate the specific time zone where Tim is located in the USA the present disclosure calculates, as shown, the earliest possible local time as 3:35 p.m. and the latest local time shown as 8:35 p.m. based on the span of local time zones of Tim's current location according to the incoming phone number's country code.

Similarly, in addition to the time information and country information, the date information of the selected entry can also be shown on the user interfaces of FIGS. 13, 14 and 15.

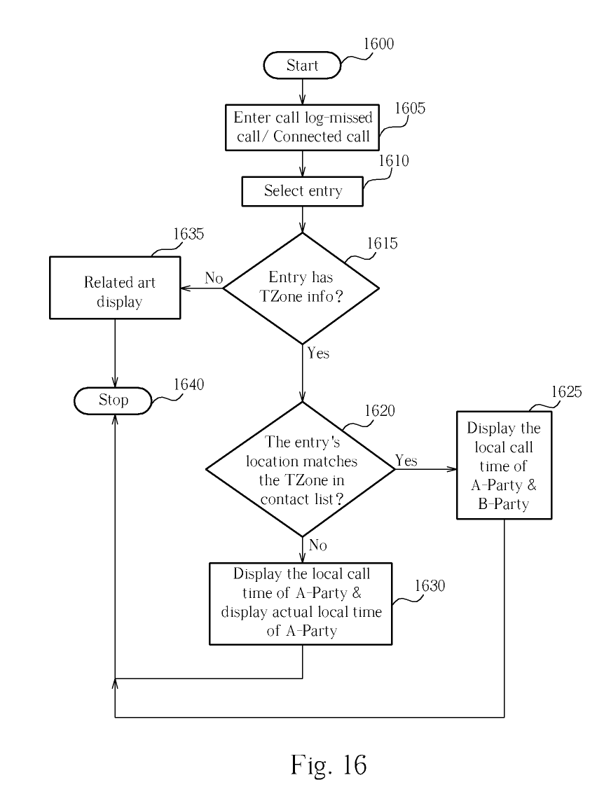

Please refer to FIG. 16. FIG. 16 is a flowchart showing a method for displaying entries of a call log/history of the communication device of FIG. 1 according to an embodiment of the present disclosure. Please note that the call log of FIGS. 13-15 can include missed call information as well. In FIG. 16 missed call information is included in the call log. In some embodiments of the present disclosure, it is possible to store any additional information in the call log as determined by the requirements. The method of the present invention comprises the following steps:

Step 1600: Start.

Step 1605: Display the call log (missed calls or connected calls or both).

Step 1610: Select an entry.

Step 1615: Does the entry have TZone information? If yes then go to step 1620. If no, then go to step 1635.

Step 1620: Does entry's actual location match TZone field in contact list 112? If yes, go to step 1625. If no, go to step 1630.

Step 1625: Calculate the local time of A-party and B-party and display. Go to step 1640.

Step 1630: Calculate the local time of A-party and B-party and the actual local time of A-party, and display. Go to 1640.

Step 1635: Display information according to the conventional call handling.

Step 1640: Stop.

The flow beings in step 1600. In step 1605, the user of the communication device 100 enters the call log. The call log can consist of received calls, connected calls, missed call, placed calls, or any combination of said calls including other related information as needed by the application. In step 1610, a specific entry of the call log is selected. In step 1615, the selected entry is checked for having stores/recorded TZone information in the contact list 112. If no then simply display the call log according to related art methods, however, if TZone information is available then proceed to step 1620. In step 1620, if the entry's location matches that entry's TZone field in the contact list 112 then go to step 1625 and display the local time of A-party and B-party, then go to step 1640 to terminate. In step 1620, if the match is unsuccessful, then go to step 1630 to display the local time of A-party and B-party as well as the actual local time of the geographic location of A-party according A-party's country code of the incoming phone number. Please note that, in step 1630, if A-party was traveling abroad in a country that has more than one time zone, the user interface of FIG. 15 is displayed. Finally, the flow stops in step 1640.

In some embodiments of the present disclosure, the communication device 100 can be realized as an attachment that interfaces with the mobile phone, either in a hardware or software form.

In summary, the present disclosure methods and communication device for displaying local time of the entries of a contact list/call log immediately calculates the local time of A-party and B-party and A-party's actual location according to the country code should it vary from the TZone information in the contact list. Access to this immediate local time offers tremendous utility to the user of the communication device in determining how appropriate a particular phone call may be prior to placing the phone call.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method for displaying entries of a contact list on a first communication device, the method comprising:
associating at least a specific time zone with an entry in the contact list; and
when the entry is referenced, determining a specific local time associated with the entry according to a local time of the communication device, the specific time zone, and a time zone of the first communication device, and displaying the specific local time.

2. The method of claim 1, wherein the contact list is in an electronic phone book.

3. The method of claim 2, wherein the first communication device is a cellular phone.

4. The method of claim 1, wherein the entry is referenced when receiving an incoming communication request from a second communication device corresponding to the entry.

5. The method of claim 4, wherein the step of associating the specific time zone with the entry further comprises associating a specific country identifier with the entry; the incoming communications request includes a country identifier, and the step of determining the specific local time associated with the entry further comprises:
when the country identifier is different from the specific country identifier, determining the specific local time associated with the entry according to the local time of the communication device, at least a time zone associated with the country identifier of the incoming communications request, and the time zone of the first communication device.

6. The method of claim 5, wherein the step of determining the specific local time associated with the entry comprises:
when the country identifier of the incoming communications request is associated with a plurality of time zones, determining the specific local time associated with the entry by setting an earliest local time and a latest local time according to the local time of the communication device, the time zones associated with the country identifier of the incoming communications request, and the time zone of the first communication device.

7. The method of claim 5, further comprising:
when the country identifier is different from the specific country identifier, replacing the specific time zone with the time zone associated with the country identifier of the incoming communications request.

8. The method of claim 4, wherein the contact list is in an electronic phone book.

9. The method of claim 8, wherein the first communication device and the second communication device are cellular phones.

10. A communication device for displaying entries of a contact list, the contact list having a plurality of entries for storing names, and telephone numbers, the communication device comprising:
a storage device, for storing a program execution code, the contact list, and settings;
a microprocessor, coupled to the storage device, for executing the program execution code to associate at least a specific time zone with an entry in the contact list, determine a specific local time associated with the entry according to a local time of the communication device, the specific time zone, and a time zone of the communication device, and displaying the specific local time, wherein the specific time zone is selected from a plurality of time zones stored in the sittings, the local time of the communication device is stored in the settings, and the time zone of the communication device is stored in the settings.

11. The communication device of claim 10, wherein the contact list is in an electronic phone book.

12. The communication device of claim 11, being a cellular phone.

13. The communication device of claim 10, wherein the entry is referenced when receiving an incoming communications request from another communication device corresponding to the entry.

14. The communication device of claim 13, wherein the incoming communications request includes a country identifier and the program execution code further associates a specific country identifier with the entry and then determines the specific local time associated with the entry according to the local time of the communication device, at least a time zone associated with the country identifier of the incoming communications request, and the time zone of the communication device when the country identifier is different from the specific country identifier.

15. The communication device of claim 14, wherein the program execution code further determines the specific local time associated with the entry by setting an earliest local time and a latest local time according to the local time of the communication device, the time zones associated with the country identifier of the incoming communications request, and the time zone of the communication device when the country identifier of the incoming communications request is associated with a plurality of time zones.

16. The communication device of claim 14, wherein the program execution code further replaces the specific time zone with the time zone associated with the country identifier of the incoming communications request when the country identifier is different from the specific country identifier.

17. The communication device of claim 13, wherein the contact list is in an electronic phone book.

18. The communication device of claim 17, wherein the communication device and another communication device are cellular phones.
